(19) United States
(12) Patent Application Publication
(10) Pub. No.: US 2012/0140513 A1
(43) Pub. Date: Jun. 7, 2012

(54) LIGHT GUIDE PLATE, LIGHT GUIDE UNIT, LIGHTING DEVICE, AND DISPLAY DEVICE

(75) Inventors: Satoshi Shibata, Osaka-shi (JP); Tsuyoshi Kamada, Osaka-shi (JP); Hideki Uchida, Osaka-shi (JP)

(73) Assignee: Sharp Kabushiki Kaisha, Osaka-shi, Osaka (JP)

(21) Appl. No.: 13/389,607

(22) PCT Filed: Jul. 7, 2010
(86) PCT No.: PCT/JP2010/061553

§ 371 Date: Feb. 9, 2012

(30) Foreign Application Priority Data
Nov. 26, 2009 (JP) 2009-269161

(51) Int. Cl. F21V 7/04; F21V 8/00

(52) U.S. Cl. 362/602; 362/609; 362/615

(57) ABSTRACT

An illumination device (10) includes (i) a light guide plate (1) made from a light-transmitting material, (ii) a light extracting layer (7) including (a) a light reflecting member, which is provided on a first surface (lower surface (1a)) side of the light guide plate (1), for reflecting light (3) that enters from the light guide plate (1) such that the light (3) is emitted from a second surface (upper surface (1b)) side of the light guide plate (1), the second surface facing the first surface of the light guide plate (1) and (b) a shutter member for switching between transmission and non-transmission of light, and (iii) LEDs (2) each serving as a primary light source. The light guide plate (1) includes a plurality of pillar regions (4) which are provided in a direction perpendicular to an in-plane direction of the light guide plate (1), and which have a refractive index different from that of the light-transmitting material. This makes it possible to provide a novel light guide unit, an illumination device and the like that can carry out an area active driving.

### TECHNICAL FIELD

The present invention relates to a novel light guide plate, a light guide unit including the light guide plate, an illumination device, and a display device.

### BACKGROUND ART

Recently, a backlight (hereinafter also referred to as a B/L) in which a light guide plate is used has been in widespread use as a backlight used in, for example, a liquid crystal display device. The light guide plate distributes, in an in-plane direction of the light guide plate, light that enters the light guide plate from a light source by guiding the light in the light guide plate. The light guide plate normally has an upper or lower surface, on which a light reflective member is provided. The light guide plate entirely emits light by reflecting the light by use of the light reflective member. In this manner, the light guide plate functions as a uniform planar light source.

The B/L including the light guide plate can be classified depending on a difference in how light enters the light guide plate. A B/L in which light enters a light guide plate from a plurality of point light sources (for example, light emitting diodes (LEDs)) provided in an edge surface (edge) of the light guide plate is called a side light-entry type B/L (see Patent Literatures 1 and 2). A B/L in which light enters a light guide plate from a plurality of point light sources provided in a lower surface of the light guide plate (a surface that faces a surface from which light is emitted) is called a direct type B/L (see Patent Literature 3).

The B/L described in Patent Literature 1 includes the light guide plate in which through holes are formed in the vicinity of the LEDs, the LEDs provided in the edge surface of the light guide plate, and a reflective plate provided on a lower surface of the light guide plate. The light guide plate has the lower surface, on which a plurality of minute crimps or the like (light extracting members) are provided. The lower surface functions as a light diffusing surface. There is provided a reflecting section having a shape of a semi-cylindrical side surface, on an edge surface of the light guide plate, which edge surface is located in the vicinity of the LEDs. The reflecting section prevents light leakage from the edge surface. Light that enters the light guide plate from the LEDs provided in an edge part of the light guide plate is efficiently distributed in an in-plane direction of the light guide plate through the through holes. Light reflected by the lower surface of the light guide plate is emitted as diffused light from an upper surface (a light emitting surface) of the light guide plate (see particularly FIG. 1 of Patent Literature 1).

The B/L described in Patent Literature 2 includes the light guide plate, the LEDs provided in the edge surface of the light guide plate, a reflective plate provided on a lower surface of the light guide plate, and a light leakage modulator provided on an upper surface (a light emitting surface) of the light guide plate (see particularly FIG. 7 of Patent Literature 2). The light leakage modulator has a high refractive region in which a low refractive region having a cylindrical shape is provided. This allows the light leakage modulator to propagate more light while restricting a light leakage effect up to farther from the LEDs. That is, the B/L described in Patent Literature 2 is configured such that the low refractive region is provided in a layer different from the light guide plate, and light emitted from the light guide plate to the light leakage modulator is distributed (equalized) in an in-plane direction of the light guide plate.

The B/L described in Patent Literature 3 includes the light guide plate in which holes or projections are provided, and side light-emitting type LEDs provided in concaves formed in the light guide plate. Each of the holes or the projections has a side surface substantially perpendicular to a lower surface (a bottom surface, a surface from which light is not emitted) of the light guide plate. The holes or the projections guide light in the light guide plate to emit the light outside of the light guide plate while retaining angle distribution of the light emitted from the LEDs (see FIGS. 14 and 23 of Patent Literature 3). Note that the holes can be through holes that penetrate the light guide plate, or holes that do not penetrate the light guide plate.

### CITATION LIST

### Patent Literature

Patent Literature 1
Japanese Patent Application Publication, Tokukai No. 2001-035229 A (Publication Date: Feb. 9, 2001)
Patent Literature 2
Japanese Patent Application Publication, Tokukai No. 2002-222604 A (Publication Date: Aug. 9, 2002)
Patent Literature 3
International Publication, pamphlet, No. WO 2006/107105 (Publication Date: Oct. 12, 2006)

### SUMMARY OF INVENTION

### Technical Problem

However, the conventional B/Ls described in Patent Literatures 1 through 3 have an identical problem that these B/Ls cannot be used in, for example, a liquid crystal display device that is subjected to an area active driving. What is meant by the area active driving is a driving method for driving a plurality of regions into which a display section of a liquid crystal display device or the like is divided, with the goal of, for example, improving contrast of display.

That is, in a case where the conventional B/L is used in the liquid crystal display device that is subjected to the area active driving, it is necessary that (i) a light guiding condition on light guided in the light guide plate is made unfulfilled in a given region and (ii) light is emitted from the light guide plate under the light guiding condition. That is, it is necessary to set the light guiding condition as follows. In a region of the light guide plate, from which region light is not emitted, light is distributed merely in the light guide plate (namely, light is not emitted outside of the light guide plate). However, in the conventional B/L, a light path is changed to not only a direction in which light travels in the light guide plate but also a direction in which light is emitted outside of the light guide plate. This causes light leakage.

A reason why the light leakage is caused is as follows. In the conventional B/L, distribution of light in the light guide plate, and light emission outside of the light guide plate are simultaneously carried out by a function of the light guide plate. That is, in the case where the conventional B/L is used in the liquid crystal display device that is subjected to the area active driving, it is necessary not only that, in the region from which light is not emitted, the light path is not changed to a thickness direction of the light guide plate (a direction to a display surface), and light is distributed merely in the light guide plate but also that the light path is changed to the thickness direction of the light guide plate in the region from which light is emitted.

The B/L described in Patent Literature 1 is basically an invention that relates to a B/L used in a mobile LCD (Liquid Crystal Display) including one (1) LED. In the B/L described in Patent Literature 1, merely a configuration of the vicinity of a light entering section of the LED is considered. Therefore, the B/L described in Patent Literature 1 has difficulty in being used in, for example, a large-screen liquid crystal display device.

The B/L described in Patent Literature 3 is a direct type B/L. Therefore, the B/L described in Patent Literature 3 has a problem of requiring more LEDs than those required for a side light-entry type B/L. Even in a case where a side light-emitting type LED is used, there is a problem that it is necessary to take measures on upward light emission from the LEDs, as described in Patent Literature 1.

The present invention was made in view of the problems, and a main object of the present invention is to provide a novel light guide plate capable of carrying out the area active driving, a light guide unit, an illumination device, and a display device.

### Solution to Problem

In order to attain the object, a light guide unit of the present invention, including: a light guide plate made from a light-transmitting material; a plurality of pillar regions which (i) are provided in the light guide plate in a direction perpendicular to an in-plane direction of the light guide plate and (ii) have a refractive index different from that of the light-transmitting material; and a light extracting layer provided on a first surface side of the light guide plate, the light extracting layer, including: a light reflecting member for reflecting light that enters from the light guide plate such that the light is emitted from a second surface of the light guide plate, the first surface and the second surface facing each other; and a shutter member, which is provided between the light guide plate and the light reflecting member, for switching between transmission and non-transmission of light or for switching between transmission and scattering of light.

According to the configuration, light that enters the light guide plate is refracted when entering the plurality of pillar regions provided in the light guide plate, and therefore, a light path of the light is changed in the in-plane direction of the light guide plate. This allows the light to be distributed so as to spread in the in-plane direction of the light guide plate. In contrast, light that enters the light extracting layer from a surface of the light guide plate selectively reaches the light reflecting member through the shutter member. Thereafter, the light is reflected by the light reflecting member, and is then selectively emitted outside of the light guide plate after passing again through the shutter member.

That is, in the light guide unit of the present invention, distribution of light in the in-plane direction of the light guide plate, and selective emission (extraction) of light outside of the light guide plate are carried out in different layers. This yields an effect that the distribution of light, and the selective emission of light outside of the light guide plate can be independently controlled. It is therefore possible to provide a novel light guide unit that can be used in, for example, a display device that is subjected to an area active driving.

Another object of the present invention is to provide (i) an illumination device including the light guide unit, and at least one (1) primary light source provided in an edge surface of the light guide plate, (ii) a display device in which the illumination device is employed as a backlight and (iii) a novel light guide plate used in, for example, the light guide unit.

### Advantageous Effects of Invention

The present invention yields an effect that, for example, a novel light guide unit capable of carrying out an area active driving can be provided.

### BRIEF DESCRIPTION OF DRAWINGS

FIG. 1 is a perspective view schematically showing a configuration of an illumination device of the present invention.

FIG. 2 is a top view schematically showing the configuration of the illumination device shown in FIG. 1.

FIG. 3 is a side view schematically showing the configuration of the illumination device shown in FIG. 1.

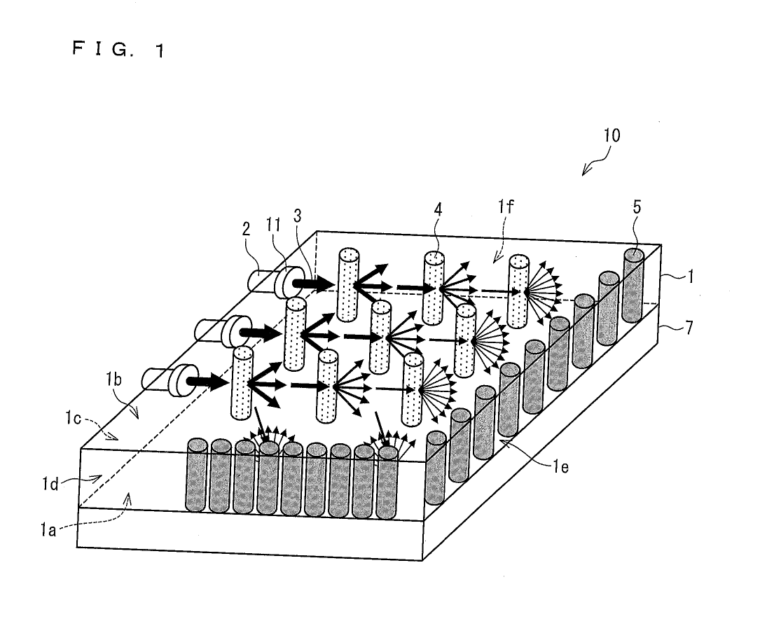

In FIG. 4, each of (a) through (c) is a view showing an example of a detailed configuration of a light extracting layer included in the illumination device of FIG. 1.

### DESCRIPTION OF EMBODIMENTS

### Embodiment 1

(Basic Configurations of Light Guide Unit and Illumination Device)

The following description will discuss an example of basic configurations of an illumination device, and a light guide unit including a light guide plate of the present invention, with reference to FIGS. 1 through 3.

An illumination device 10 of the present invention includes a light guide plate 1, a plurality of LEDs (Light Emitting Diodes) 2 each serving as a primary light source, and a light extracting layer 7. The light extracting layer 7 emits, outside of the light guide plate 1, light that enters the light guide plate 1, so that the illumination device 10 functions as a secondary light source. That is, the illumination device 10 separately includes (i) a mechanism (the light guide plate 1) for broadly guiding, in the light guide plate 1, light that emitted from the primary light sources and (ii) a mechanism (the light extracting layer 7) for extracting guided light. This makes it easier to control extracting of the guided light, as compared with a case where both mechanisms are attained in a single configuration of a light guide plate.

It is possible to provide a backlight unit that can also carry out an area active driving of a display device, by controlling the backlight unit to emit light from merely a desired region of a surface of the light guide plate 1, as later described. The following description will discuss in detail a configuration of the illumination device 10. Note that, in the present embodiment, the illumination device 10 including no LED 2 that serves as the primary light sources is defined as a “light guide unit” that does not emit light by itself but guides light that enters the light guide unit.

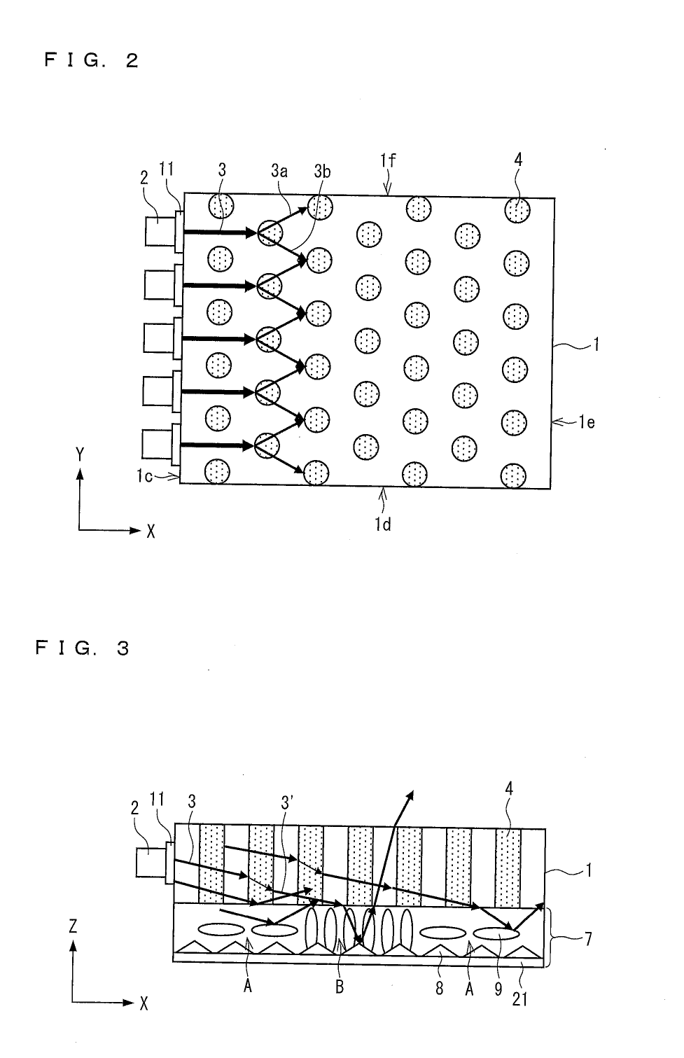

The light guide plate 1 is, for example, a plate member, having an oblong shape, which is made from a light-transmitting material (a medium of a light guide plate) publicly known as a material for a light guide plate, such as glass, acrylic resin, polycarbonate, or silicone resin. The light guide plate 1 includes four edge surfaces 1c through 1f, an upper surface 1b, and a lower surface 1a. Light source attaching sections 11 (see FIG. 2), via which the respective primary light sources are to be attached, are provided on the edge surface 1c of the four edge surfaces 1c through 1f. A plurality of LEDs 2 are attached to the respective light source attaching sections 11. Light reflecting members 5, each having a cylindrical shape, are aligned along inner surfaces of the edge surfaces 1d through 1f, to which no LED 2 is attached, such that there is no space left between any adjacent ones of the light reflecting members 5. That is, the light reflecting members 5 are aligned along each of the inner surfaces of the edge surfaces 1d through 1f such that each of the inner surfaces creates a light reflective wall that regularly projects in a curved manner toward inside of the liquid guide plate. Each of the light reflecting members 5 is made from a material such as aluminum, silver, or a dielectric multilayer reflective film.

More specifically, the light reflecting members 5 can be made by, for example, providing, on each of the edge surfaces 1d through 1f of the light guide plate 1, a thin metallic line having a wire shape. The thin metallic line has a diameter that is not particularly limited. It is, however, preferable that the diameter falls within a range from approximately 50 μm to 100 μm, in terms of easy production. Of course, a fine metallic line such as a nano-wire can be used as the light reflecting member 5. The fine metallic line can be provided on the edge surfaces by means of, for example, adhesion by use of resin, or thermal fusion bonding. Alternatively, the fine metallic line can be provided on each of the edge surfaces by adhering, to the edge surface of the light guide plate via air, a film prepared in advance in which fine metallic lines are aligned with no space left between any adjacent fine metallic lines.

Instead of the provision of the light reflecting members 5 on each of the edge surfaces, each of the edge surfaces 1d through 1f of the light guide plate 1 can have a function identical to that of the light reflecting members 5 by being processed. Specifically, for example, cylindrical through holes are formed in each of the edge surfaces 1d through 1f of the light guide plate 1. Thereafter, each of the edge surfaces 1d through 1f is cut such that each of the through holes has a substantially semi-cylindrical cross section, and then a reflective material such as aluminum, silver, or a dielectric multilayer reflective film is formed on the surface of the through hole thus cut.

There are provided, in the light guide plate 1, a plurality of pillar regions 4 each of which extends in a direction perpendicular to an in-plane direction of the light guide plate 1. The pillar region 4 is a region which is filled with a material having a refractive index different from that of the light-transmitting material. More specifically, the pillar region 4 of the present embodiment is a through hole extending in a direction substantially perpendicular to the in-plane direction of the light guide plate 1. It is preferable that the pillar region 4 has a refractive index greater than that of the light-transmitting material from which the light guide plate 1 is made. The pillar region 4 has a refractive index which is greater than that of the material of the light guide plate 1, preferably by not less than 0.05, more preferably by not less than 0.05 but not more than 0.2, most preferably by not less than 0.05 but not more than 0.1, in terms of (a) further reduction in probability of light leakage from the light guide plate 1 and (b) compatibility of light guiding with distribution of light. In a case where the material of the light guide plate 1 is glass, acrylic resin, polycarbonate, or silicone resin, examples of the material with which the pillar region 4 is filled encompass (i) resins, such as epoxy acrylate, urethane acrylate, and polyfluorene and (ii) any of the resins in each of which nanoparticles of a metal oxide are dispersed.

In this specification, what is meant by “the in-plane direction of the light guide plate 1” is a direction parallel to the upper surface 1b and the lower surface 1a. Note that, in a case where neither the upper surface 1b nor the lower surface 1a are parallel to each other, what is meant by “the in-plane direction of the light guide plate 1” is a direction parallel to a plane equally distant from the upper surface 1b and the lower surface 1a (that is, a center plane of the light guide plate 1).

As described later, the pillar regions 4 contribute to uniform light guiding in the light guide plate 1. The pillar regions 4 are regularly aligned with respect to alignment of the plurality of LEDs 2. Specifically, the plurality of pillar regions 4 are aligned along a direction in which the plurality of LEDs 2 are provided in the edge surface 1c. In a case where alignments of the pillar regions 4 are referred to as a first column, a second column, a third column, . . . , in an order of being closer to the alignment of the plurality of LEDs 2, (i) pillar regions 4 aligned in the first column and (ii) pillar regions 4 aligned in the second column aligned in zigzag (that is, in a staggered manner). That is, in a case where the light guide plate 1 is viewed from the edge surface 1c side, each of the pillar regions 4 in the second column is aligned so as to be located between corresponding adjacent two of the pillar regions 4 in the first column. Pillar regions 4 in any adjacent columns (for example, the second column and the third column) are aligned so as to meet a relationship between the first column and the second column.

As shown in FIG. 2, the plurality of LEDs 2 attached to the edge surface 1c of the light guide plate 1 emit light 3, having a great directivity, inwards the light guide plate 1. The light 3 that enters the light guide plate 1 is refracted when the light 3 enters the pillar regions 4, and a light path of the light 3 is changed in the in-plane direction of the light guide plate 1 (see refracted light 3a and refracted light 3b of FIG. 2). This causes the light 3 to be evenly distributed so as to spread in the in-plane direction of the light guide plate 1.

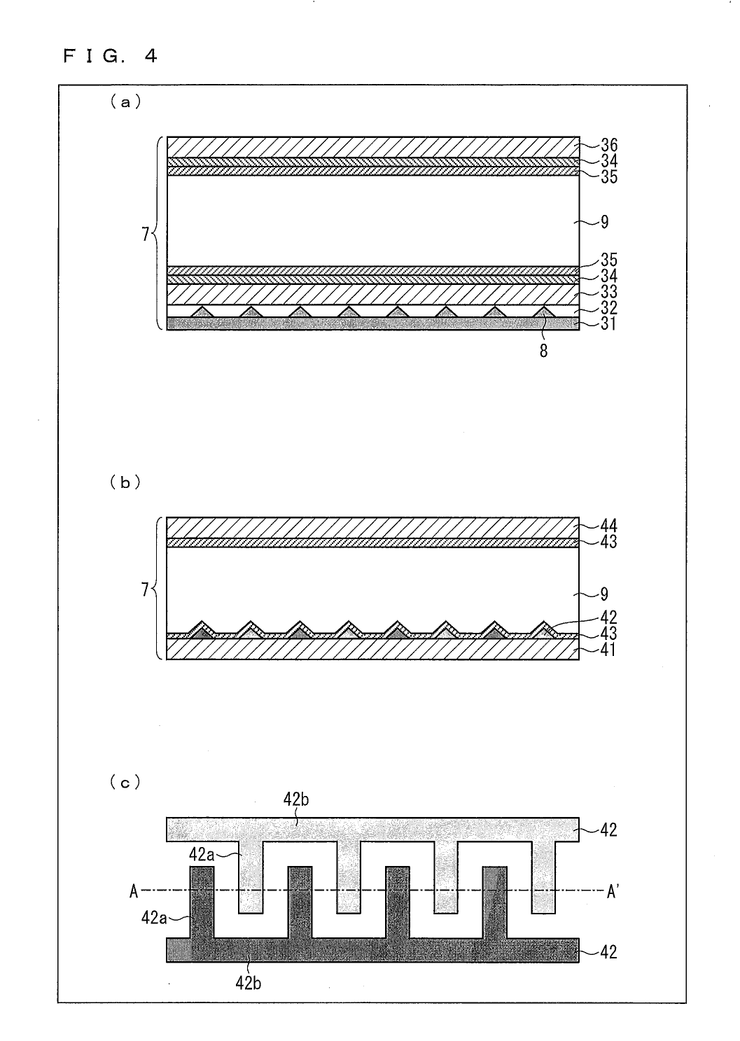

Further, as shown in FIG. 3, each of the pillar regions 4 has a side surface substantially perpendicular to the in-plane direction of the light guide plate 1 (the upper surface 1b that is a surface from which light is emitted). Therefore, a direction, in which the light 3 that enters the pillar region 4 travels in the thickness direction of the light guide plate 1, is refracted (see the light 3 in FIG. 3). However, when the light 3 enters again the light guide plate 1 via the side surface of the pillar region 4, it travels in the same direction as the direction in which the light 3 enters the light guide plate 1 (see light 3′ in FIG. 3). Therefore, the light path is maintained. That is, the entry angle of the light 3 to the light guide plate 1 is maintained as it is while the light 3 is traveling in the light guide plate 1. Accordingly, utilization of the light guide plate 1 makes it possible to evenly distribute the light 3 in merely the in-plane direction while keeping a light guiding condition.

When the light 3, that has been distributed in the in-plane direction of the light guide plate 1, reaches the edge surfaces 1d through 1f, the light 3 (stray light) is reflected from the side surface of the light reflecting members 5, and is then guided again inwards the light guide plate 1. This prevents undesired light leakage (light loss) from the light guide plate 1, thereby further improving an efficiency in utilization of light supplied from the primary light sources (LEDs 2).

(Configuration of Light Extracting Layer)

The light extracting layer 7 is provided on the lower surface 1a (a surface) of the light guide 1. The light extracting layer 7 includes light reflecting members 8 for reflecting light that received from the light guide plate 1 such that the light is directed outside of the upper surface 1b, the upper surface 1b and the lower surface 1a facing each other. The light extracting layer 7 is provided to be located between the light guide plate 1 and the light reflecting members 8. The light extracting layer 7 includes a shutter member for switching between transmission and non-transmission of light (state of light transmission) or for switching between transmission and scattering of light. More specifically, the light extracting layer 7 includes (i) the light reflecting members 8, each of which has a reflective surface and is made from a light reflective material such as aluminum, silver, or a dielectric multilayer reflective film and (ii) a liquid crystal layer (shutter member) 9 containing a liquid crystal material. The light extracting layer 7 is configured such that the light reflecting members 8 face the light guide plate 1 via the liquid crystal layer 9. The light extracting layer 7 has a plane surface area substantially equal to that of the lower surface 1a of the light guide plate 1. The light extracting layer 7 is provided so as to cover the entire lower surface 1a.

Each of the light reflecting members 8 is a member, having a shape of triangular prism, which extends in a direction in which the columns of the pillar regions 4 are aligned in the light guide plate 1 (that is, a direction in which the plurality of LEDs 2 are aligned). The light reflecting member 8 has a bottom surface (a bottom surface of the triangular prism) having a shape of isosceles triangle with a single obtuse angle. The light reflecting members 8 each have an opposite side surface of the obtuse angle. The opposite side surfaces of the respective light reflecting members 8 are fixed to a substrate 21. The light reflecting members 8 are fixed to the substrate 21 so that there is no space left between any adjacent ones of the light reflecting members 8. It follows that the light reflecting members 8 form, on the substrate 21, a continuous light reflective surface alternating between peak and valley. That is, the illumination device 10 is configured such that the liquid crystal layer 9 is sandwiched between (i) the continuous light reflective surface formed by the light reflecting members 8 and (ii) the light guide plate 1.

The light 3, which has been guided in the light guide plate 1, enters the light extracting layer 7. Note that, in an interface between the material (low refractive region) of the light guide plate 1 and the light extracting layer 7, most of the light 3 enters the light extracting layer 7, whereas, in an interface between the pillar regions (high refractive regions) 4 of the light guide plate 1 and the light extracting layer 7, most of the light 3 is subjected to total reflection, and is then guided in the light guide plate 1.

When the light enters the light extracting layer 7, it first reaches the liquid crystal layer 9. The liquid crystal layer 9 serves as a shutter for switching, in response to an applied voltage, between transmission and reflection (non-transmission) of the light 3 that enters the liquid crystal layer 9. Specifically, the shutter includes the liquid crystal layer 9, a pair of driving electrodes that face each other via the liquid crystal layer 9, and a liquid crystal driving circuit (not shown) for applying a voltage signal between the pair of electrodes. The shutter independently drives (divisionally drives) a plurality of regions into which the liquid crystal layer 9 is divided. In the liquid crystal layer 9, liquid crystal molecules, in a region A where a voltage is applied, have an orientation state different from that in a region B where no voltage is applied (see FIG. 3). For example, in a case where vertical orientation type liquid crystal molecules are used, the liquid crystal molecules of the region A orient in a direction parallel to the light extracting layer 7, whereas the liquid crystal molecules of the region B orient in a direction perpendicular to the light extracting layer 7 (see FIG. 3).

Consequently, when the light enters the region A of the liquid crystal layer 9 from the light guide plate 1 side, it is subjected to total reflection by the liquid crystal molecules, and is then guided again in the light guide plate 1. The light 3 propagates in the light guide plate 1 while substantially keeping an entry angle of the light 3 (that is, a direction substantially parallel to the in-plane direction of the light guide plate 1), and then enters the light extracting layer 7. When the light 3 is subjected to the total reflection by the liquid crystal molecules, the light 3 enters the light extracting layer 7 at a relatively obtuse angle. As such, the light 3 that enters, again after the total reflection, the light guide plate 1 from the light extracting layer 7 is guided so as to uniformly spread in the in-plane direction of the light guide plate 1.

In contrast, when the light 3 enters the region B of the liquid crystal layer 9 from the light guide plate 1 side, it reaches, via the space between the liquid crystal molecules, the continuous light reflective surface formed by the light reflecting members 8. Then, the light 3 is reflected by the continuous light reflective surface. As early described, since the continuous light reflective surface is configured so as to alternate between peak and valley, the light 3 is subjected to total reflection at an acute angle by the continuous light reflective surface. As such, the light 3, that has been thus subjected to the total reflection, enters again the light guide plate 1 at an acute angle. It follows that the light 3 is emitted from the upper surface 1b of the light guide plate 1, instead of being guided in the in-plane direction of the light guide plate 1.

That is, the illumination device 10 emits light from merely a region, on the light guide plate 1, which corresponds to the region B of the liquid crystal layer 9. In contrast, substantially just the distribution (guide) of the light is carried out in the in-plane direction of the light guide plate 1 in a region, on the light guide plate 1, which corresponds to the region A of the liquid crystal layer 9. Therefore, no light is emitted outside of the illumination device 10 from such a region.

According to the illumination device 10, (i) the distribution of light in the light guide plate 1 and (ii) the emission of light outside of the light guide plate 1 are thus carried out in respective different layers. It is, therefore, possible to independently control the distribution of light and the emission of light. For example, the illumination device 10 can emit, by controlling the light extracting layer 7, light from the entire upper surface 1b of the light guide plate 1 or can emit light from merely a specific region of the upper surface 1b. Therefore, the illumination device 10 can be a planar light source (backlight unit) that can be employed in, for example, a liquid crystal display device that is subjected to an area active driving. A side light-entry type area active B/L, such as the illumination device 10, has advantages in reduction in cost of a device, low power consumption, and reduction in thickness of a device, as compared with a conventional configuration. Note that what is meant by the area active driving is a driving method for driving a plurality of regions into which a display section of a liquid crystal display device or the like is divided, with the goal of, for example, improving contrast of display.

Note also that each of the light extracting layer 7 and the light guide plate 1 included in the illumination device 10 has a simplified configuration. It is therefore possible to easily enlarge the light extracting layer 7 and the light guide plate 1. It is also possible to relatively easily meet the demand of enlargement of a screen of, for example, a liquid crystal display device in which the illumination device 10 is employed as a backlight.

(Example of a Detailed Configuration of the Light Extracting Layer 7)

The following description will discuss an example of a detailed configuration of the light extracting layer 7, with reference to FIG. 4. Note that the light extracting layer 7 is not limited to a specific one, and is applicable to the present invention, provided that the light extracting layer 7 includes (i) a light reflecting member for reflecting light that enters from the light guide plate 1 and (ii) a shutter member, which is provided between the light guide plate 1 and the light reflecting member, for switching between transmission and non-transmission of light or for switching between transmission and scattering of light, as early described with reference to FIG. 3.

(a) of FIG. 4 is a cross-sectional view schematically showing a configuration of the light extracting layer 7. The light extracting layer 7 includes a pair of transparent substrates 33 and 36, the liquid crystal layer 9 (shutter member) provided between the pair of transparent substrates 33 and 36, a light-shielding (light non-transmitting) support substrate 31, and the plurality of light reflecting members 8 provided over the support substrate 31. Each of the transparent substrates 33 and 36 has a surface facing the liquid crystal layer 9, on which surface a liquid crystal driving electrode 34 and an alignment film 35 are provided in this order. The liquid crystal layer 9 functions as a shutter member in response to an applied voltage to the electrodes 34.

The support substrate 31 is adhered to the transparent substrate 33 via a transparent adhesive resin layer 32 such that the surface of the support substrate 31, on which surface the plurality of light reflecting members 8 are provided, faces the transparent substrate 33. The transparent substrate 36 has a surface adhered to the light guide plate 1 (see FIG. 3), (i) the surface and (ii) the other surface of the transparent substrate 36 which other surface faces the liquid crystal layer 9 and the like, facing each other.

Light, that has entered the light extracting layer 7 from the light guide plate 1 side, is controlled, in the liquid crystal layer 9, to be transmitted or to be reflected. Some of the light selectively reaches the light reflecting members 8, is reflected by the light reflecting members 8, and is then controlled again, in the liquid crystal layer 9, to be transmitted or to be reflected. Some of the reflected light selectively enters the light guide plate 1, and is then emitted outside of the light guide plate 1.

(b) of FIG. 4 is a cross-sectional view schematically showing another example of the configuration of the light extracting layer 7. The light extracting layer 7 includes a support substrate 41 having light-shielding and electrically insulating properties, a transparent substrate 44, a liquid crystal layer 9 (shutter member) provided between the support substrate 41 and the transparent substrate 44, and a liquid crystal driving comb-teeth electrode 42 (which also serves as a light reflecting member). The support substrate 41 has a surface facing the liquid crystal layer 9, on which surface the comb-teeth electrode 42 and an alignment film 43 are provided in this order. The transparent substrate 44 has a surface facing the liquid crystal layer 9, on which surface an alignment film 43 is provided. The transparent substrate 44 has the other surface adhered to the light guide plate 1 (see FIG. 3), (i) the other surface and (ii) the surface of the transparent substrate 44 which surface faces the liquid crystal layer 9 and the like, facing each other.

As shown in (c) of FIG. 4, the comb-teeth electrode 42 is made up of a pair of comb-teeth electrodes, which include respective linear parts 42b that extend parallel to each other and each of which includes a plurality of teeth parts 42a each extending so as to be perpendicular to a corresponding one of the linear parts 42b. The pair of the comb-teeth electrodes 42 are provided so that the plurality of teeth parts 42a of one of the pair of comb-teeth electrodes 42 mesh with those of the plurality of teeth parts 42a of the other of the pair of comb-teeth electrodes 42. A voltage is applied to the liquid crystal layer 9, via the pair of comb-teeth electrodes 42.

Note that (b) of FIG. 4 corresponds to a cross-sectional view taken along A-A′ line of (c) of FIG. 4. As shown in (b) of FIG. 4, at least the plurality of comb teeth parts 42a of each of the comb-teeth electrodes 42 each have a shape of triangular prism. The comb-teeth electrode 42 is made from, for example, a light reflecting metal such as aluminum or silver. This allows the comb-teeth electrode 42 to also serve as a light reflecting member.

That is, light that has entered the light extracting layer 7 from the light guide plate 1 side is controlled, in the liquid crystal layer 9, to be transmitted or to be reflected. Some of the light selectively reaches the comb-teeth electrode 42 which also serves as the light reflecting member, and is then reflected by the comb-teeth electrode 42. Thereafter, the light that has been reflected is controlled again, in the liquid crystal layer 9, to be transmitted or to be reflected. Some of the light selectively enters the light guide plate 1, and is then emitted outside of the light guide plate 1.

(Modified Example of Light Guide Unit and Illumination Device)

The pillar regions 4 are not limited to specific ones, provided that the pillar regions 4 have a refractive index different from that of the material of the light guide plate. A concrete example of a material for the pillar regions 4 is a structure filled with a light-transmitting material such as epoxy acrylate, urethane acrylate, or polyfluorene (note that the material of the pillar regions 4 is a material having a refractive index different from that of the material of the light guide plate, preferably a material having a refractive index greater than that of the material of the light guide plate). Alternatively, the pillar regions 4 can be hollow sections filled with air.

The illumination device 10 is described with an example in which the liquid crystal layer 9 is employed as the shutter member constituting the light extracting layer 7. However, the shutter member is not particularly limited to this. Alternatively, for example, another type of optical shutter for use in an illumination device can be used.

Further, the illumination device 10 is described with an example in which the pillar regions 4 in the light guide plate 1 have a cylindrical shape. However, the shape of the pillar regions 4 is not limited to the cylindrical shape. Pillar regions 4 having a cylindrical shape and pillar regions 4 having different shape and/or different size can coexist in an identical light guide plate 1, if necessary. Not only the shape and the size of the pillar regions 4 in the light guide plate 1 but also, for example, how to align the pillar regions 4 and pitches at which the pillar regions 4 are aligned are not limited to those shown in the drawings.

For example, the shape of the pillar regions 4 in the light guide plate 1 is not limited to a specific one. Examples of the shape of the pillar regions 4 encompass a triangular prism, a quadrangular prism, an elliptic cylinder, and a cylinder. For example, pillar regions 4 having shapes of not less than two of the above examples can be used so as to coexist in the light guide plate 1. Examples of the case in which the pillar regions 4 having the shapes of not less than two of the above examples are used so as to coexist in the light guide plate 1 encompass (i) a case in which pillar regions 4 having a cylindrical shape and pillar regions 4 having a shape of multangular prism (for example, a shape of quadrangular prism) coexist in the light guide plate 1 and (ii) a case in which pillar regions 4 having shapes of different multangular prisms (for example, a shape of triangular prism and a shape of quadrangular prism) coexist in the light guide plate 1.

The size of the pillar regions 4 is not limited to a specific one. Examples of the size (an equivalent diameter) of the pillar region 4 encompass (i) not less than 300 μm but not more than 1 mm, (ii) not less than 1 mm but not more than 5 mm, and (iii) not less than 5 mm but not more than mm. More concrete examples of the size (equivalent diameter) of the pillar regions 4 encompass 0.1 mm, 0.3 mm, 0.5 mm, and 1 mm. A plurality of pillar regions 4 in one (1) light guide plate 1 can have an identical size or different sizes. Concrete examples in which the plurality of pillar regions 4 have different sizes encompass (i) an example in which the size (equivalent diameter) of the pillar regions 4 increases gradually as the pillar regions 4 are located farther from the edge surface 1c (primary light entering surface) of the light guide plate 1, to which edge surface 1c the LEDs 2 are attached, (ii) an example in which the size of the pillar regions 4 decreases gradually as the pillar regions 4 are located farther from the edge surface 1c of the light guide plate 1, and (iii) an example in which the pillar regions 4 having different sizes randomly coexist in the light guide plate 1.

How to align the pillar regions 4 is not limited to a specific one. Examples of how to align the pillar regions 4 encompass an alignment shown in FIG. 2 (an alignment in a staggered manner), a honeycomb alignment, and a random alignment. A typical example of the honeycomb alignment is an alignment in which six pillar regions 4 are aligned so as to surround one pillar region 4, in other words, the pillar regions 4 are aligned so as to have a so-called hexagonal closest packing structure.

The pitches at which the pillar regions 4 are aligned (that is, alignment interval) are not limited to a specific one. Examples of the pitches encompass (i) not less than 1 mm but not more than 5 mm, (ii) not less than 5 mm but not more than 10 mm, and (iii) not less than 10 mm but not more than 20 mm. Other examples of the pitches encompass uniform pitches, pitches that increase gradually as the pillar regions 4 are located farther from the edge surface 1c (primary light entering surface) of the light guide plate 1, to which edge surface 1c the LEDs 2 are attached, pitches that decrease gradually as the pillar regions 4 are located farther from the edge surface 1c of the light guide plate 1, and random pitches at which the pillar regions 4 are aligned.

In a case where the pillar regions 4 are provided at uniform pitches, concrete examples of the uniform pitches encompass 1 mm, 5 mm, and 10 mm.

It is preferable that the pillar regions 4 have a refractive index greater than that of the material (glass, transparent resin or the like) for the light guide plate. However, the pillar regions 4 can have a refractive index lower (smaller) than that of the material for the light guide plate.

The above-exemplified configuration (hollow or filled with a light-transmitting material), refractive index, shape, size, and alignment of the pillar regions 4, and the pitches at which the pillar regions 4 are aligned can be used in arbitrary combination, in order to obtain a desired optical distribution in the light guide plate 1.

(More Concrete Example of Light Guide Unit and Illumination Device)

Pillar regions 4 of the illumination device 10 shown in FIGS. 1 through 3 were prepared so as to have the following concrete shape, size, alignment, and pitches at which the pillar regions 4 were aligned.

(1) Basic Structure

Pillar regions 4 have either a cylindrical or elliptically cylindrical shape, an identical size (equivalent diameter) of 300 μm, and a refractive index of 1.6 (high refractive resin). The pillar regions 4 are provided in a honeycomb alignment (hexagonal closest packing structure). Identical pitches at which the pillar regions 4 are aligned are 1 mm. The material (low refractive resin) for the light guide plate 1 has a refractive index of 1.5.

(2) Modified Structure 1

Pillar regions 4 have a shape of either triangular prism or quadrangular prism, an identical size (equivalent diameter) of 300 μm, and a refractive index of 1.6 (high refractive resin). The pillar regions 4 are provided in a honeycomb alignment (hexagonal closest packing structure). Identical pitches at which the pillar regions 4 are aligned are 1 mm. The material (low refractive resin) for the light guide plate 1 has a refractive index of 1.5.

In a case where the pillar regions 4 have a shape of either triangular prism or quadrangular prism, it is preferable that the pillar regions 4 are provided such that a side surface of each of the pillar regions 4, which side surface is located on the primary light entering surface (the edge surface 1c) side, is at angles with the edge surface 1c of the light guide plate 1, which edge surface 1c serves as the primary light entering surface (that is, such that the side surface of each of the pillar regions 4 is not parallel to the edge surface 1c). It is more preferable that the pillar regions 4 are provided such that the pillar regions 4 appear to be symmetrical in a case where one of the pillar regions 4 is viewed from the edge surface 1c side. This makes it possible to further uniformly distribute light in the light guide plate 1.

(3) Modified Structure 2

Pillar regions 4 having a cylindrical shape, and pillar regions 4 having a shape of multangular prism coexist in the light guide plate 1. The pillar regions 4 have an identical size (equivalent diameter) of 300 μm, and a refractive index of 1.6 (high refractive resin). The pillar regions 4 are provided in a honeycomb alignment (hexagonal closest packing structure). Identical pitches at which the pillar regions 4 are aligned are 1 mm. The material (low refractive resin) for the light guide plate 1 has a refractive index of 1.5. Note that it is preferable that the pillar regions 4 having a shape of multangular prism are provided such that a side surface of each of the pillar regions 4 having the shape of multangular prism, which side surface is located on the primary light entering surface side, is at angles with the edge surface 1c of the light guide plate 1, which edge surface 1c serves as the primary light entering surface (that is, such that the side surface of each of the pillar regions 4 having the shape of multangular prism is not parallel to the edge surface 1c). It is more preferable that the pillar regions 4 having the shape of multangular prism are provided such that the pillar regions 4 having the shape of multangular prism appear to be symmetrical in a case where one of the pillar region 4 having the shape of multangular prism is viewed from the edge surface 1c side. This makes it possible to further uniformly distribute light in the light guide plate 1.

(4) Modified Structure 3

Pillar regions 4 have either a cylindrical or elliptically cylindrical shape, an identical size (equivalent diameter) of 300 μm, and a refractive index of 1.6 (high refractive resin). The pillar regions 4 are provided in a honeycomb alignment (hexagonal closest packing structure). Pitches at which the pillar regions 4 are aligned increase (a density at which the pillar regions 4 are distributed becomes thin) gradually as the pillar regions 4 are located farther from the edge surface 1c of the light guide plate 1. The material (low refractive resin) for the light guide plate 1 has a refractive index of 1.5. That is, in Modified Structure 3, the pillar regions 4 are aligned so as to be closest to one another in the vicinity of a region (the primary light entering section) in which the LEDs 2 are provided. Further, in Modified Structure 3, the pitches at which the pillar regions 4 are aligned are decreased as the pillar regions 4 are located closer to the edge surface from which the LEDs 2 emit light, so that unevenness of quantity of light emitted from the LEDs 2 is reduced. This makes it possible to further efficiently distribute light.

(5) Modified Structure 4

Pillar regions 4 have either a cylindrical or elliptically cylindrical shape, and a refractive index of 1.6 (high refractive resin). The size (equivalent diameter) of the pillar region 4 is reduced gradually as the pillar regions 4 are located farther from the edge surface 1c of the light guide plate 1. The pillar regions 4 are provided in a honeycomb alignment (hexagonal closest packing structure). Identical pitches at which the pillar regions are aligned are 1 mm. The material (low refractive resin) for the light guide plate 1 has a refractive index of 1.5.

That is, in Modified Structure 4, the pillar regions 4 are provided such that quantity of light that enters the pillar regions 4 is reduced as the pillar regions 4 are located farther from the region (the primary light entering section) to which the LEDs 2 are attached. Further, in Modified Structure 4, light is further efficiently distributed as the pillar regions 4 are located closer to the edge surface from which the LEDs 2 emit light, so that unevenness of quantity of light emitted from the LEDs 2 is reduced.

(6) Modified Structure 5

Pillar regions 4 have either a cylindrical or elliptically cylindrical shape, and a refractive index of 1.6 (high refractive resin). The size (equivalent diameter) of the pillar regions 4 is increased gradually as the pillar regions 4 are located farther from the edge surface 1c of the light guide plate 1. The pillar regions 4 are provided in a honeycomb alignment (hexagonal closest packing structure). Pitches at which the pillar regions 4 are aligned increase (a density at which the pillar regions 4 are distributed becomes thin) gradually as the pillar regions 4 are located farther from the edge surface 1c of the light guide plate 1. The material (low refractive resin) for the light guide plate 1 has a refractive index of 1.5.

That is, in Modified Structure 5, the pillar regions 4 are aligned so as to be closest to one another and so as to have the smallest size in the vicinity of a region (the primary light entering section) in which the LEDs 2 are provided.

(Display Device of the Present Invention)

A display device of the present invention includes the illumination device 10 of the present invention as a backlight. The display device of the present invention is not limited to a specific type of display device provided that the display device of the present invention is a display device in which a backlight is employed. Concrete examples of the display device of the present invention encompass a television receiver, and a liquid crystal display device used in, for example, a display section of a mobile phone. Among these, the display device of the present invention is suitably applicable to a liquid crystal display device used in a large-size television receiver. This is because reduction in thickness, and low power consumption are strongly required for such a large-size television receiver.

As described above, the illumination device 10 of the present invention can emit, by controlling the light extracting layer 7, light from the entire upper surface 1b of the light guide plate 1 or can emit light from merely a specific region of the upper surface 1b. Therefore, the illumination device 10 of the present invention can be a planar light source that can be used in, for example, a liquid crystal display device that is subjected to an area active driving. Note that what is meant by the area active driving is a driving method for driving a plurality of regions into which a display section of a liquid crystal display device or the like is divided, with the goal of, for example, improving contrast of display.

(Light Guide Plate of the Present Invention)

A light guide plate of the present invention includes: a light guide plate (light guide plate 1) made from a light-transmitting material; a plurality of pillar regions (pillar regions 4) which (i) are provided in the light guide plate 1 in a direction perpendicular to an in-plane direction of the light guide plate 1 and (ii) have a refractive index different from that of the light-transmitting material; and an attaching section (light source attaching section 11) which is provided in an edge surface of the light guide plate 1, and to which a primary light source (LED 2) is attached. That is, the light guide plate of the present invention is a side light-entry type light guide plate. It is therefore possible to further reduce the number of required primary light sources, as compared with a direct type light guide plate.

The present invention is not limited to the description of the embodiments above, and can therefore be modified by a skilled person in the art within the scope of the claims. Namely, an embodiment derived from a proper combination of technical means disclosed in different embodiments is encompassed in the technical scope of the present invention.

(Preferable Structure)

It is preferable to configure the light guide unit of the present invention in terms of keeping a light guiding condition (an entry angle of light) in the light guide plate such that each of the plurality of pillar regions have a side surface substantially perpendicular to the in-plane direction of the light guide plate.

According to the configuration, light that is refracted in a thickness direction of the light guide plate when entering the pillar regions is refracted again when being emitted from the pillar regions (when entering the light guide plate again). This makes it possible to keep an entry angle of light with respect to the light guide plate as it is.

It is more preferable to configure the light guide unit of the present invention in terms of preventing light leakage from the light guide plate such that the plurality of pillar regions have a refractive index greater than that of the light-transmitting material.

It is preferable to configure the light guide unit of the present invention in terms of easy production such that the plurality of pillar regions are provided so as to penetrate the light guide plate.

It is more preferable to configure the light guide unit of the present invention such that the light extracting layer include (i) a liquid crystal layer which functions as the shutter member and (ii) the light reflecting member, and the light reflecting member face the light guide plate via the liquid crystal layer.

According to the configuration, the light that enters the light extracting layer from the light guide plate reaches the light reflecting member via the liquid crystal layer that is driven in response to an applied voltage. The liquid crystal layer functions as a shutter for causing light to reach merely a desired region of the light reflecting member, so that the light can be emitted outside of the light guide unit. This makes it possible to provide a novel light guide unit that can be used in, for example, a display device that is subjected to an area active driving.

### INDUSTRIAL APPLICABILITY

According to the present invention, it is possible to provide, for example, a novel light guide unit that can carry out an area active driving.

### REFERENCE SIGNS LIST

1: light guide plate
1c: edge surface
2: LED (primary light source)
4: pillar region
7: light extracting layer
8: light reflecting member
9: liquid crystal layer (shutter member)
10: illumination device
11: light source attaching section (attaching section)

1. A light guide unit, comprising:
a light guide plate made from a light-transmitting material;
a plurality of pillar regions which (i) are provided in the light guide plate in a direction perpendicular to an in-plane direction of the light guide plate and (ii) have a refractive index different from that of the light-transmitting material; and
a light extracting layer provided on a first surface side of the light guide plate,
the light extracting layer, including:
a light reflecting member for reflecting light that enters from the light guide plate such that the light is emitted from a second surface of the light guide plate, the first surface and the second surface facing each other; and
a shutter member, which is provided between the light guide plate and the light reflecting member, for switching between transmission and non-transmission of light or for switching between transmission and scattering of light.

2. The light guide unit as set forth in claim 1, wherein:
each of the plurality of pillar regions has a side surface substantially perpendicular to the in-plane direction of the light guide plate.

3. The light guide unit as set forth in claim 1, wherein:
the plurality of pillar regions have a refractive index greater than that of the light-transmitting material.

4. The light guide unit as set forth in claim 1, wherein:
the plurality of pillar regions are hollow sections provided in the light guide plate.

5. The light guide unit as set forth in claim 1, wherein:
the plurality of pillar regions are provided so as to penetrate the light guide plate.

6. The light guide unit as set forth in claim 1, wherein:
the light extracting layer includes (i) a liquid crystal layer which is driven in response to an applied voltage to function as the shutter member and (ii) the light reflecting member, and
the light reflecting member faces the light guide plate via the liquid crystal layer.

7. An illumination device, comprising:
a light guide unit recited in claim 1; and
at least one primary light source attached to an edge surface of the light guide plate.

8. A display device, in which an illumination device recited in claim 7 is employed as a backlight.

9. A light guide plate, comprising:
a light guide plate made from a light-transmitting material;
a plurality of pillar regions which (i) are provided in the light guide plate made from the light-transmitting material in a direction perpendicular to an in-plane direction of the light guide plate made from the light-transmitting material and (ii) have a refractive index different from that of the light-transmitting material; and
an attaching section which is provided in an edge surface of the light guide plate, and to which a primary light source is attached.
